(19) United States
(12) Patent Application Publication
(10) Pub. No.: US 2013/0243212 A1
(43) Pub. Date: Sep. 19, 2013

(54) ACTIVE NOISE INTERFERENCE SYSTEM

(71) Applicant: Bradley Paul Sugden, (US)

(72) Inventor: Bradley Paul Sugden, (US)

(21) Appl. No.: 13/418,384

(22) Filed: Mar. 13, 2012

(51) Int. Cl. G10K 11/16

(52) U.S. Cl. 381/71.1

(57) ABSTRACT

Provided is an active noise interference system. The active noise interference system may comprise a first microphone, a controller, a speaker, and an electrical power unit. The first microphone may be mounted within a first cavity defined by a tire-wheel system. The speaker may be mounted within the first cavity. The electrical power unit may be engaged with a component set comprising the first microphone, or the controller, or the speaker, or a combination thereof. The electrical power unit may be adapted to provide electrical power to the component set.

### TECHNICAL FIELD

The present subject matter relates generally to a tire. More, specifically, the present subject matter relates to a system comprising a tire and an active noise interference system.

### BACKGROUND

Vehicles typically comprise multiple vehicle systems. Manufacturers of vehicles and vehicle systems have employed active and passive methods to reduce or otherwise change noise within the vehicle systems.

Vehicle systems may include tire-wheel systems. Noise may emanate from the tire-wheel system.

Active methods to change noise may include an active noise interference (ANI) system. An ANI system may utilize means to create an interfering noise adapted to attenuate the target noise.

It remains desirable to develop an active noise interference system for use in close conjunction with a tire-wheel system.

### SUMMARY

Provided is an active noise interference system. The active noise interference system may comprise a first microphone, a controller, a speaker, and an electrical power unit. The first microphone may be mounted within a first cavity defined by a tire-wheel system. The speaker may be mounted within the first cavity. The electrical power unit may be engaged with a component set comprising the first microphone, or the controller, or the speaker, or a combination thereof. The electrical power unit may be adapted to provide electrical power to the component set.

Further provided is a tire wheel system. The tire wheel system may comprise a wheel, a tire, an internal cavity, and an active noise interference system. The tire may be mounted on the wheel. The internal cavity may be defined by the tire and the wheel. The active noise interference system may comprise components engaged with the tire or the wheel. The active noise interference system may comprise a first microphone mounted within said internal cavity, a controller, a speaker mounted within said internal cavity, and an electrical power unit. The electrical power unit may be engaged with a component set comprising the first microphone, or the controller, or the speaker, or a combination thereof. The electrical power unit may be adapted to provide electrical power to the component set.

Further provided is an active noise interference system. The active noise interference system may comprise a first microphone, a controller, a speaker, an electrical power unit, and an error microphone. The microphone may be mounted within a first cavity defined by a tire-wheel system. The microphone may be adapted to detect a target noise and may be adapted to output a first signal representative of the target noise. The controller may be operationally engaged with the first microphone to receive the first signal therefrom and may be adapted to generate a second signal based, at least in part, on the first signal. The speaker may be mounted within the first cavity. The speaker may be operationally engaged with the controller to receive the second signal therefrom and may be adapted to output an interference noise. The interference noise may be adapted for active noise cancellation of the target noise. The electrical power unit may be engaged with a component set comprising the first microphone, or the controller, or the speaker, or a combination thereof. The electrical power unit may be adapted to provide electrical power to the component set. The electrical power unit may comprise a battery, or an electric generator, or a kinetic energy recovery device, or a connection to a vehicle power supply. The error microphone may be mounted within the first cavity. The error microphone may be adapted to output an error signal representative of the combination of the target noise and the interference noise.

### BRIEF DESCRIPTION OF THE DRAWINGS

FIG. 1a shows a partial cross-sectional view of one embodiment of an active noise interference system in conjunction with an associated tire-wheel system.

FIG. 1b shows a partial cross-sectional view of one embodiment of an active noise interference system in conjunction with an associated tire-wheel system.

FIG. 1c shows a partial cross-sectional view of one embodiment of an active noise interference system in conjunction with an associated tire-wheel system.

FIG. 2 is a schematic view of an active noise interference system (ANI) system.

FIG. 3 shows a partial cross-sectional view of one embodiment of an active noise interference system in conjunction with an associated tire-wheel system and an associated vehicle

### DETAILED DESCRIPTION

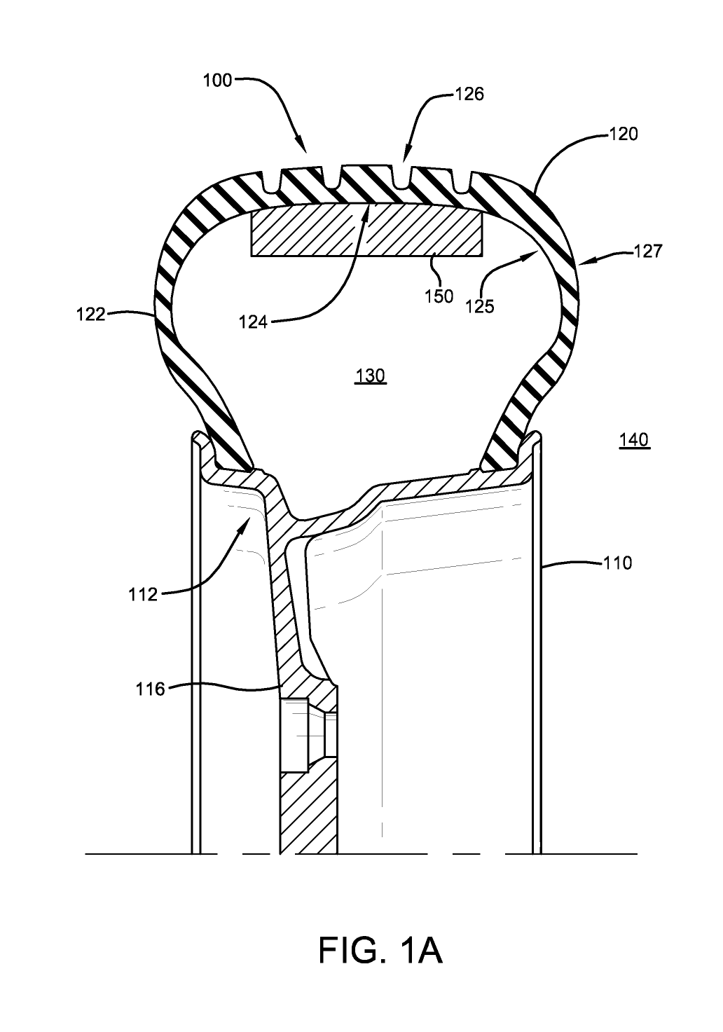

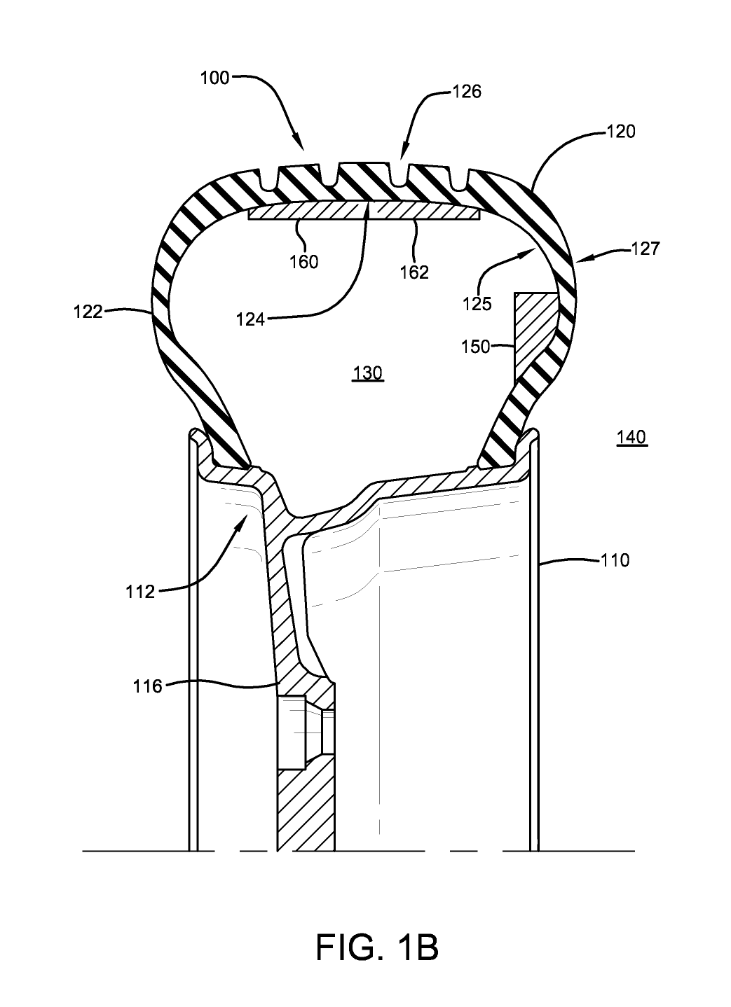

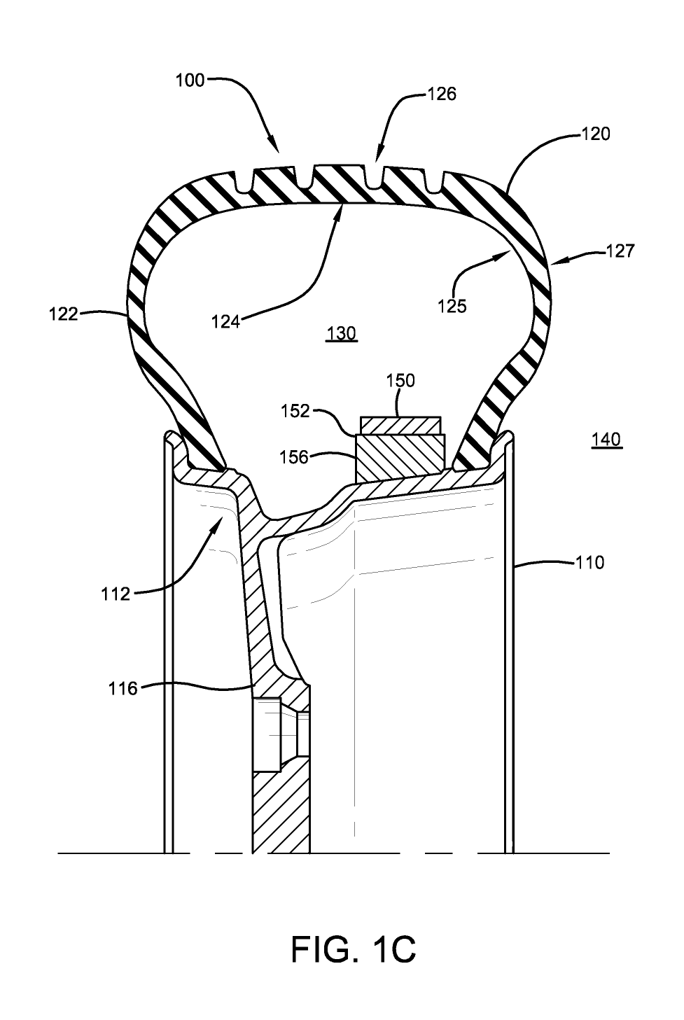

Reference will be made to the drawings, FIGS. 1-3, wherein the showings are only for purposes of illustrating certain embodiments of an active wave interference system and of an active wave interference system engaged with an associated tire wheel system and/or an associated vehicle.

As used herein, active noise control refers generally to use of a sound generating system to effect or change noise in some way. Active noise control is not limited to cancellation of a noise; it may include changing, either decreasing or increasing, a noise or one or more frequencies of a noise.

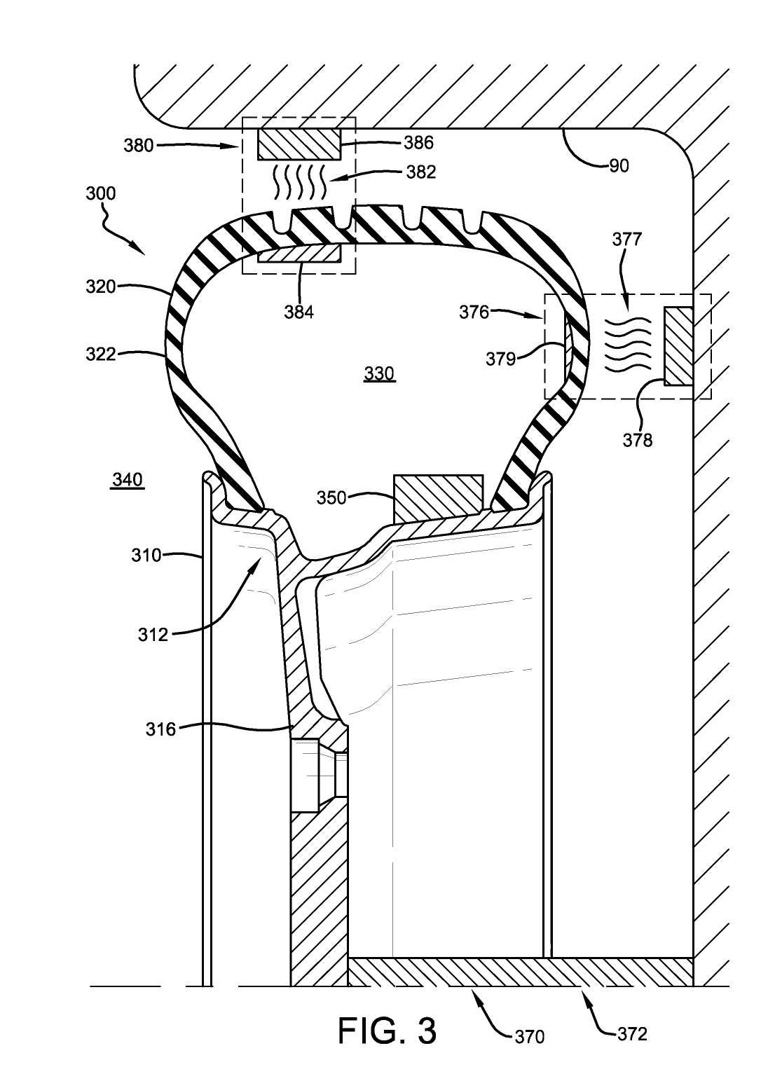

Referring now to FIGS. 1a, 1b, 1c, and 3, shown are various embodiments of an active noise interference system in conjunction with an associated tire-wheel system 100, 300. The tire wheel system 100, 300 comprises a wheel 110, 310 and a tire 120, 320. Wheel 110, 310 may comprise any of various kinds of wheels designed to have a tire 120, 320 mounted thereabout. In the embodiments shown in FIGS. 1a, 1b, 1c, and 3, wheel 110, 310 comprises a rim portion 112, 312 adapted for engagement with tire 120, 320 and a plate portion 116, 316 adapted for engagement with an associated vehicle 90. Tire 120, 320 may comprise any kind of tire designed to mount to wheel 110, 310. In the embodiments shown in FIGS. 1a, 1b, 1c, and 3, tire 120, 320 is a pneumatic vehicle tire 122, 322 but it should be understood that in other embodiments tire 120, 320 may comprise a non-pneumatic tire, a truck tire, a motorcycle tire, a bicycle tire, or another kind of tire. In the embodiments shown in FIGS. 1a, 1, 1c, and 3, the tire 120, 320 and the wheel 110, 310 together define an internal cavity 130, 330. In embodiments in which the tire 120, 320 is a pneumatic tire 122, 322 the internal cavity may be substantially isolated from the surrounding environment 140, 340 by the tire 120, 320 and the wheel 110, 310 and may, optionally, be inflated to some pressure above that of the surrounding environment 140, 340.

As used herein, engagement, unless otherwise noted, may refer to direct engagement or indirect engagement. In direct engagement, the engaged elements are in direct contact with one another. In indirect engagement, the engaged elements are not in direct contact with one another but are indirectly engaged by one or more intermediate components.

With further reference to FIG. 1a, in the embodiment shown therein, an active noise interference (ANI) system 150 is engaged with the tire wheel system 100. The active noise interference (ANI) system 150 may be positioned within the internal cavity 130. As shown in FIG. 1a, active noise interference (ANI) system 150 may be positioned within the internal cavity 130 and may be directly engaged with tire 120. In other embodiments, a sub-set of the components of the active noise interference (ANI) system 150 may be positioned within the internal cavity 130. In general, the sub-components of an active noise interference system 150 may be mounted or positioned in a manner similar to that in which an entire active noise interference system 150 may be mounted or positioned. Engagement with tire 120 may be by engagement with a first interior surface 124 opposite an external tread surface 126.

With reference to FIG. 1b, in the embodiment shown therein, an active noise interference (ANI) system 150 is engaged with the tire wheel system 100. As shown in FIG. 1b, active noise interference (ANI) system 150 is positioned within the internal cavity 130 and is engaged with a second interior surface 125 opposite an external sidewall surface 127.

With reference to FIG. 1c, in the embodiment shown therein, an active noise interference (ANI) system 150 is engaged with the tire wheel system 100. As shown in FIG. 1c, active noise interference (ANI) system 150 is positioned within the internal cavity 130 and is indirectly engaged with wheel rim 112. As shown in FIG. 1c, the active noise interference (ANI) system 150 is directly engaged with an intermediate component 152 and intermediate component 152 is directly engaged with wheel rim 112. The intermediate component 152 may be a tire pressure monitoring system 156.

In another embodiment, active noise interference (ANI) system 150 may be positioned within the internal cavity 130 and may be engaged with some other interior surface of tire 120. In general, engagement of the active noise interference (ANI) system 150, or a sub-set of the components of the active noise interference (ANI) system 150, to the tire 120 or to the wheel 112 may be by direct engagement or indirect engagement. The active noise interference (ANI) system 150 may be engaged with a tire 120, or a wheel 112, or to an intermediate component 152 with means that would be typical for engaging a tire pressure monitoring system 156, including, but not limited to an adhesive, a mechanical fastener, a magnet, or overmolding. In some embodiments, the active noise interference (ANI) system 150 may be engaged with a valve stem (not shown).

With continued reference to FIGS. 1a, 1b, 1c, and 3 as a tire wheel system 100, 300 operates it rotates and either rolls or slides over a roadway surface (not shown). As it operates, the tire wheel system 100, 300 may generate noise or may be close to another noise generator. In either case, whether the tire wheel system 100, 300 may generate noise or may be close to another noise generator, the noise will be referred to herein as noise generated from a source proximate to the tire wheel system 100, 300. Noise generated from a source proximate to the tire wheel system 100, 300 may emanate from said source. It is possible to reduce or otherwise affect this generated noise using an active noise interference (ANI) system 150, 200, 350. As used herein, unless otherwise noted, the noise that an active noise interference (ANI) system 150, 200, 350 is to control will be referred to as target noise 205. That is, the target noise 205 is the noise that is sought to be reduced or otherwise controlled by use of the active noise interference (ANI) system 150, 200, 350. An active noise interference (ANI) system 150, 200, 350 may be mounted proximate to the tire wheel system 100, 300 to assist in reducing target noise emanating from a source proximate to the tire wheel system 100, 300.

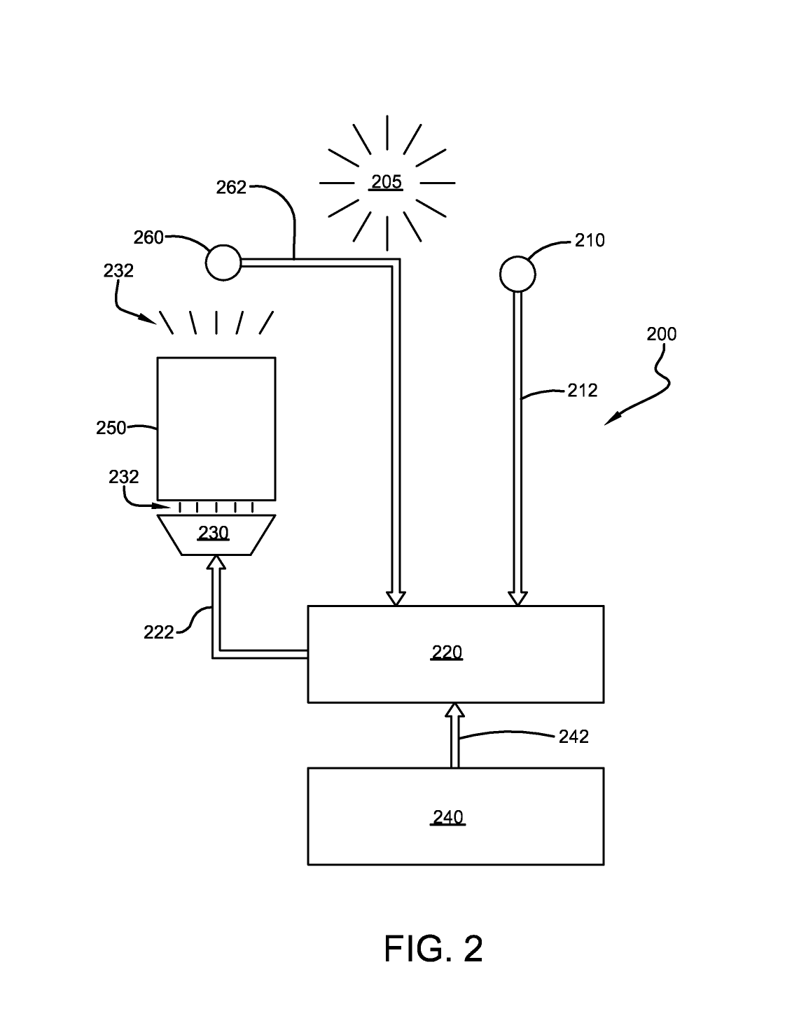

FIG. 2 shows one embodiment of an active noise interference (ANI) system 150, 200, 350. The ANI system 150, 200, 350 may comprise a first microphone 210 operationally engaged with a controller 220; a speaker 230 operationally engaged with the controller 220; and an electrical power unit 240 operationally engaged with said microphone 210, or said controller 220, or said speaker 230, or some combination thereof. The ANI system 150, 200, 350 may further comprise an acoustic resonator 250, a second microphone 260, or some combination thereof. The ANI system 150, 200, 350 may further comprise additional microphones (not shown) additional speakers (not shown), and/or additional acoustic resonators (not shown) engaged to the controller 220 in a manner similar to that of their analogous components as shown in FIG. 2. Some of the components of the ANI system 150, 200, 350 may be mounted within the internal cavity 130, 330 defined by the tire-wheel system 100, 300. Some of the components of the ANI system 150, 200, 350 may be mounted proximate to the tire-wheel system 100, 300. Some of the components of the ANI system 150, 200, 350 may be mounted distal from the tire-wheel system 100, 300 such as, without limitation, to an associated vehicle 90.

The first microphone 210 is a transducer adapted to produce an electrical signal in response to and characteristic of a sound. The first microphone 210 may be adapted to produce a first signal 212 in response to a target noise 205. In some embodiments, the first microphone 210 may be mounted within internal cavity 130, 330.

The controller 220 is a processor adapted to receive a first signal 212 and to generate a second signal 222 based on one or more factors. The one or more factors may comprise the first signal 212. In the embodiment shown in FIG. 2, the controller 220 produces a second signal 222 based on one or more factors comprising the first signal 212 which was in turn, produced in response to target noise 205. Accordingly, in the embodiment shown in FIG. 2, the controller 220 is operationally engaged with the first microphone 210 to receive the first signal 212 therefrom and is adapted to generate a second signal 222 based on the first signal 212. The controller 220 may be operationally engaged to the first microphone 210 to receive the first signal 212 therefrom by any means of transmitting first signal 212. Means of transmitting first signal 212 may include, but are not limited to, wiring, cables, optic fibers, Ethernet, radio transmission, infra-red transmission, cellular transmission, Bluetooth, Wi-Fi, or other methods chosen using good engineering judgment. In certain embodiments the controller 220 may comprise or be in operational engagement with a digital computer such as, but not limited to, a desk top computer, a lap top computer, or a smart phone. As will be further described herebelow, the one or more factors may comprise signals, variables, or other inputs that may comprise, without limitation, the first signal 212, a signal from another microphone 260, time, weighting factors, or a combination thereof. The controller 220 may be mounted within internal cavity 130, may be mounted to the tire-wheel system 100, 300 outside of the internal cavity 130, may be mounted to an associated vehicle 90, or may be away from any associated vehicle 90.

The speaker 230 is a transducer adapted to produce a sound in response to an electrical signal. In the embodiment shown in FIG. 2, the speaker 230 is operationally engaged with controller 220 to receive a second signal 222 from controller 220. The speaker 230 may be operationally engaged with the controller 220 to receive the second signal 222 therefrom by any means of transmitting second signal 222. Means of transmitting second signal 222 may include, but are not limited to, wiring, cables, optic fibers, Ethernet, radio transmission, infra-red transmission, cellular transmission, Bluetooth, Wi-Fi, or other methods chosen using good engineering judgment. In some embodiments the means of transmitting second signal 222 is the same as the means of transmitting first signal 212. In the embodiment shown in FIG. 2, the speaker 230 is adapted to output an interference noise 232. The interference noise 232 may be a noise adapted for active noise cancellation of the target noise 205. That is, the interference noise 232 may be a noise adapted to destructively interfere with the target noise 205. In certain embodiments, the interference noise 232 may be a noise adapted to constructively or destructively interfere with the target noise 205 or particular wavelengths thereof. The speaker 230 may be mounted within internal cavity 130.

An acoustic resonator 250 is a device that exhibits resonant behavior such that it naturally oscillates at particular frequencies, the particular frequencies being resonant frequencies, with greater amplitude than at other frequencies. The oscillations of interest in an acoustic resonator are acoustic oscillations and the resonance of interest is acoustic resonance. Acoustic resonance is the tendency of an acoustic resonator to absorb more energy when it is driven at a frequency that matches one of its own resonant frequencies than it does at other frequencies. As shown in FIG. 2, the optional acoustic resonator 250 may be adapted to modify the interference noise 232 to strengthen specific frequencies or to weaken specific frequencies, or some combination thereof. In the embodiment shown in FIG. 2, an optional acoustic resonator 250 may be operationally engaged with speaker 230 to receive an interference noise 232 from speaker 230. In the embodiment shown in FIG. 2, the optional acoustic resonator 250 is adapted to output an interference noise 232. As noted above, the interference noise 232 output from an optional acoustic resonator 250 may differ from an input interference noise 232 in that specific frequencies of the interference noise 232 may be strengthened or specific frequencies may be weakened, or some combination thereof. If the ANI system 150, 200, 350 comprises an optional acoustic resonator 250 the interference noise 232 output therefrom is adapted for active noise cancellation of a target noise 205. An optional acoustic resonator 250 may be mounted within internal cavity 130, 330.

An optional error microphone 260 is a transducer adapted to produce an electrical signal in response to a sound. The optional error microphone 260 may be adapted to produce an error signal 262 representative of the combination of target noise 205 and interference noise 232. The optional error microphone 260 may be located in a particular area wherein the interference noise 232 is adapted to effectively counteract target noise 205. The optional error microphone 260 creates error signal 262 which may be fed back to controller 220 and may be used as one of the one or more factors used by controller 220 upon which second signal 222 is based. The controller 220 may be operationally engaged to the error microphone 260 to receive the error signal 262 therefrom by any means of transmitting error signal 262. Means of transmitting error signal 262 may include, but are not limited to, wiring, cables, optic fibers, Ethernet, radio transmission, infra-red transmission, cellular transmission, Bluetooth, Wi-Fi, or other methods chosen using good engineering judgment. In some embodiments the means of transmitting error signal 262 is the same as the means of transmitting first signal 212 or the second signal 222. Accordingly, in certain embodiments, an ANI system 150, 200, 350 comprises an error microphone 260 that is adapted to produce an error signal 262 as a function of a combination comprising target noise 205 and interference noise 232, and wherein the error signal 262 may be sent to controller 220 and used as feedback signal to modify second signal 222. An optional error microphone 260 may be mounted within internal cavity 130.

The electrical power unit 240 is a device adapted to provide electrical power 242 to those components with which it is operationally engaged. The electrical power unit 240 may be operationally engaged with, and adapted to provide electrical power to, a first microphone 210, a controller 220, a speaker 230, an optional error microphone 260, any other components of ANI system 150, 200, 350, or a combination thereof. The electrical power unit 240 may comprise a battery, an electric generator, a kinetic energy recovery device, a connection to a vehicle power supply, or some combination thereof. In certain embodiments, a battery, an electric generator, a kinetic energy recovery device, and/or a connection to a vehicle power supply may be composed of multiple components. The electrical power unit 240 or components comprised by the electrical power unit 240 may be mounted, partially or fully, within internal cavity 130, may be mounted outside of the internal cavity 130, may be mounted to the tire-wheel system 100, 300, may be mounted proximate to tire wheel system 100, 300, may be mounted distal from tire wheel system 100, 300, and/or may be mounted to an associated vehicle 90.

In embodiments in which the electrical power unit 240 comprises a battery, the battery may be any of one or more electrochemical cells adapted to convert stored chemical energy into electrical energy. A battery may be rechargeable or non-rechargeable. A battery may comprise a zinc-carbon battery, a zinc-chloride battery, an alkaline battery, a nickel oxyhydroxide battery, a lithium battery, a mercury oxide battery, a zinc-air battery, a silver-oxide battery, a nickel-cadmium battery, a lead-acid battery, a nickel-metal hydride battery, a nickel-zinc battery, a lithium-ion battery, or some combination thereof. In embodiments in which the electrical power unit 240 comprises a battery, the battery may be mounted within internal cavity 130, may be mounted to the tire-wheel system 100, 300, may be mounted proximate to tire wheel system 100, 300, may be mounted distal from tire wheel system 100, 300, and/or may be mounted to an associated vehicle 90.

In certain embodiments, the electrical power unit 240 may comprise an electric generator 380. An electric generator 380 may be a rotary electric generator or a linear electric generator. An electric generator 380, may comprise multiple components such as, without limitation, a conductive coil 384, and either or both of a permanent magnet 386 or an electromagnetic device. In an electric generator 380, a magnetic field 382 is moved relative to a conductive coil 384 in order to induce an electric current in the conductive coil 384. The magnetic field 382, or the conductive coil 384, or both may be moved in order to create the relative movement. A conductive coil 384 may be a solenoid. A magnetic field 382 may be the magnetic field 382 from a permanent magnet 386 or from an electromagnetic device. In certain embodiments, and as shown in FIG. 3, a conductive coil 384 may be engaged with tire wheel system 100 and adapted to be rotated therewith and the magnetic field 382 may be positioned proximate to the tire wheel system 100, 300 such as by engagement of permanent magnet 386 with an associated vehicle 90, and adapted such that the tire wheel system 100 may be rotated with respect to the magnetic field 382. In such embodiments, rotation of the tire wheel system 100 during operation of the tire wheel system 100 moves the conductive coil 384 with respect to the magnetic field 382 thereby generating electric current that may be output from the conductive coil 384 as electrical power. In some embodiments in which the electrical power unit 240 comprises an electric generator 380, the electric generator 380 may be mounted within internal cavity 130, may be mounted partially within internal cavity 130 and partially outside of internal cavity 130 and proximate to tire wheel system 100, 300, may be mounted proximate to tire wheel system 100, 300, may be mounted distal from tire wheel system 100, 300, and/or may be mounted to an associated vehicle 90.

In certain embodiments, as shown in FIG. 1b, the electrical power unit 240 may comprise a kinetic energy recovery device 160. A kinetic energy recovery device 160 is a device that converts mechanical energy into electrical energy. Mechanical energy may comprise, without limitation, energy expressed as a component undergoes a strain; that is, the strain energy. A kinetic energy recovery device 160 may comprise a piezoelectric component 162. In certain embodiments, a kinetic energy recovery device 160 comprises a piezoelectric component 162 adapted to be flexed in response to operation of the tire wheel system 100 such that operation of the tire wheel system 100 causes the kinetic energy recovery device 160 to produce electrical power. Referring to the embodiment shown in FIG. 1b, a kinetic energy recovery device 160 may comprise a piezoelectric component 162 engaged with a first interior surface 124 opposite the external tread surface 126 such that the piezoelectric component 162 undergoes a flexure cycle, with a concomitant generation of electrical energy, as the first interior surface 124 with which it is engaged passes through the tire footprint during operation of the tire wheel system 100. In some embodiments in which the electrical power unit 240 comprises a kinetic energy recovery device 160, the kinetic energy recovery device 160 may be mounted within internal cavity 130, or may be mounted outside of internal cavity 130 and to tire wheel system 100, 300.

In certain embodiments, the electrical power unit 240 may comprise an electrical interface 370 to a power supply of an associated vehicle 90. The power supply of an associated vehicle 90 may comprise a vehicle battery, an alternator, or a combination thereof. An electrical interface 370 may comprise any suitable interface chosen with good engineering judgment. In certain embodiments, an electrical interface 370 may comprise a rotatable electrical interface 372 or an inductive interface 376. The electrical interface 370 may provide means to transmit electrical power between the tire-wheel system 100, and the rest of an associated vehicle 90 with respect to which the tire-wheel system 100 may undergo operational rotation.

A rotatable electrical interface 372 may comprise a slip ring, a collector, a swivel, an electrical rotary joints, or a combination thereof.

An inductive interface 376 may comprise multiple components such as, without limitation, a first inductive coil 378 and a second inductive coil 379. An inductive interface 376 uses an electromagnetic field 377 to transfer energy between a first inductive coil 378 engaged with the associated vehicle 90 and a second inductive coil 379 engaged with the tire-wheel system 300. In certain embodiments, an induction interface 376 may create an electromagnetic field 377 in the first inductive coil 378, and the second inductive coil 379 may take power from the electromagnetic field 377 and converts it into electrical current usable to power the active noise interference system 350. Two induction coils 378, 379 in proximity may perform in a manner substantially similar to that of an electrical transformer.

As noted above, and as shown in FIG. 3, an active noise interference (ANI) system 150, 350 may be positioned partially or fully within the internal cavity 130, 330. In some embodiments, such as, without limitation, that shown in FIG. 1a, all of the components of an active noise interference (ANI) system 150, 350 may be positioned within the internal cavity 130, 330. In some embodiments, such as, without limitation, that shown in FIG. 3, some of the components of an active noise interference (ANI) system 150, 350 may be positioned within the internal cavity 130, 330 while other components are not positioned within the internal cavity 130, 330. In some embodiments, such as, without limitation, that shown in FIG. 3, some of the components of an active noise interference (ANI) system 150, 350 may be positioned partially within and partially outside of the internal cavity 130, 330. In some embodiments, a controller 220 or an electrical power unit 240 is positioned partially or fully outside of the tire wheel system 100, 300. In some embodiments, a controller 220 may be positioned away from an associated vehicle 90.

As noted above, and as shown in FIG. 2, in some embodiments, active noise interference (ANI) system 200 may comprise a means for noise sensing or detection, or means to sample a noise, such as, without limitation microphone 210 or microphone 260. In some embodiments, active noise interference (ANI) system 200 may comprise means to predict target noise 205 or means to predict a characteristic about the target noise 205. For example and not limitation, the resonant frequency of an internal wheel and pneumatic tire system may be predicted upon the volume of air contained therein. Without limitation, in some embodiments an active noise control system 200 may accept information about the volume of air contained in an associated tire wheel system 100, 300 and predict thereupon the resonant frequency of the associated tire wheel system 100, and may predict the frequency of target noise 205 based thereupon. In one non-limiting embodiment, an active noise interference (ANI) system 200 may predict the frequency of target noise 205 based upon the volume of air contained in an associated tire wheel system 100, 300 and generate a constant frequency sound to interfere with the predicted target noise 205.

While the active noise interference system has been described above in connection with certain embodiments, it is to be understood that other embodiments may be used or modifications and additions may be made to the described embodiments for performing the same function of the active noise interference system without deviating therefrom. Further, the active noise interference system may include embodiments disclosed but not described in exacting detail. Further, all embodiments disclosed are not necessarily in the alternative, as various embodiments may be combined to provide the desired characteristics. Variations can be made by one having ordinary skill in the art without departing from the spirit and scope of the active noise interference system. Therefore, the active noise interference system should not be limited to any single embodiment, but rather construed in breadth and scope in accordance with the recitation of the attached claims.

What is claimed is:

1. An active noise interference system comprising:
a first microphone mounted within a first cavity defined by a tire-wheel system;
a controller;
a speaker mounted within said first cavity; and
an electrical power unit, said electrical power unit,
engaged with a component set, said component set comprising
said first microphone, or
said controller, or
said speaker, or
a combination thereof, and
adapted to provide electrical power to said component set.

2. The active noise interference system of claim 1, wherein said first microphone is adapted to detect a target noise.

3. The active noise interference system of claim 2, wherein said first microphone is adapted to output a first signal representative of said target noise.

4. The active noise interference system of claim 3, wherein said controller is operationally engaged with said first microphone to receive the first signal therefrom.

5. The active noise interference system of claim 4, wherein said controller is adapted to generate a second signal based, at least in part, on said first signal.

6. The active noise interference system of claim 5, wherein said speaker is operationally engaged with said controller to receive the second signal therefrom.

7. The active noise interference system of claim 6, wherein said speaker is adapted to output an interference noise.

8. The active noise interference system of claim 7, wherein said electrical power unit comprises
a battery, or
an electric generator, or
a kinetic energy recovery device, or
a connection to a vehicle power supply.

9. The active noise interference system of claim 8, further comprising an error microphone adapted to output an error signal representative of the combination of said target noise and said interference noise.

10. A tire wheel system comprising
a wheel;
a tire, said tire being mounted on said wheel;
an internal cavity defined by said tire and said wheel; and
an active noise interference system comprising components engaged with said tire or said wheel, said active noise interference system comprising,
a first microphone mounted within said internal cavity,
a controller,
a speaker mounted within said internal cavity, and
an electrical power unit,
engaged with a component set, said component set comprising
said first microphone, or
said controller, or
said speaker, or
a combination thereof, and
adapted to provide electrical power to said component set.

11. The tire wheel system of claim 10, wherein said first microphone is adapted to detect a target noise.

12. The tire wheel system of claim 11, wherein said first microphone is adapted to output a first signal representative of said target noise.

13. The tire wheel system of claim 12, wherein said controller is operationally engaged with said first microphone to receive the first signal therefrom.

14. The tire wheel system of claim 13, wherein said controller is adapted to generate a second signal based, at least in part, on said first signal.

15. The tire wheel system of claim 14, wherein said speaker is operationally engaged with said controller to receive the second signal therefrom.

16. The tire wheel system of claim 15, wherein said speaker is adapted to output an interference noise.

17. The tire wheel system of claim 16, wherein said electrical power unit comprises
a battery, or
an electric generator, or
a kinetic energy recovery device, or
a connection to a vehicle power supply.

18. The tire wheel system of claim 17, wherein said active noise interference system further comprises an error microphone adapted to output an error signal representative of the combination of said target noise and said interference noise.

19. The tire wheel system of claim 18, wherein said second signal is based, at least in part, on said error signal.

20. An active noise interference system comprising:
a first microphone mounted within a first cavity defined by a tire-wheel system,
said first microphone being adapted to detect a target noise, and
said first microphone being adapted to output a first signal representative of said target noise;
a controller,
said controller operationally engaged with said first microphone to receive the first signal therefrom,
said controller adapted to generate a second signal based, at least in part, on said first signal;
a speaker mounted within said first cavity,
said speaker operationally engaged with said controller to receive the second signal therefrom,
said speaker being adapted to output an interference noise,
said interference noise being adapted for active noise cancellation of said target noise;
an electrical power unit, said electrical power unit,
engaged with a component set, said component set comprising
said first microphone, or
said controller, or
said speaker, or
a combination thereof,
adapted to provide electrical power to said component set, and
said electrical power unit comprising,
a battery, or
an electric generator, or
a kinetic energy recovery device, or
a connection to a vehicle power supply; and
an error microphone adapted to output an error signal representative of the combination of said target noise and said interference noise, said error microphone being mounted within said first cavity.
